(19) United States
(12) Patent Application Publication
(10) Pub. No.: US 2008/0220402 A1
(43) Pub. Date: Sep. 11, 2008

(54) METHOD FOR CREATING A FAITH BASED LEGACY MEMORIAL

(76) Inventor: David W. Chaveriat, Petoskey, MI (US)

Correspondence Address: JOHN K. MCCORMICK, 6781 GLACIER DRIVE, WEST BEND, WI, 53090, US

(21) Appl. No.: 11/683,637

(22) Filed: Mar. 8, 2007

(51) Int. Cl. G09B 19/00

(52) U.S. Cl. 434/245

(57) ABSTRACT

The present invention is directed toward a method for capturing an individual's autobiographical life story in light of its spiritual significance to the individual prior to their demise. The method comprises capturing in a digital format the steps of having the individual, while alive, introduce themselves, explain the purpose of the audio/visual, relating their life story in terms of its spiritual significance to the individual and in closing the audio/visual recording. The spiritually significant on the items includes how they found their faith, how they were blessed, what God and life taught them, how they use and understand self-reflection, examples where their God has supported them, the significance of their place of worship, what they believe in, their favorite poems or scripture, their belief in the power of miracles, who they loved, why they believe forgiveness is important and how they shared their faith.

### TECHNICAL FIELD

The present invention relates generally to recording and displaying information about entities, and will specifically disclose a method and structured format for capturing for future presentation the faith based experiences of an individual prior to their demise.

### BACKGROUND OF THE INVENTION

Throughout recorded history, cultures and civilizations have utilized rituals and ceremonies to commemorate the loss of a loved one or a member of the community. These ceremonies can be extremely large and ornate, such as for individuals with a high public profile or high political office, or they can be simple and reserved ceremonies. The rituals and ceremonies serve a variety of needs. One of those needs is to provide a means of closure for the surviving members of the community and to aid the living in coping with the loss of someone dear to them.

Another need served by the ceremonies is to share with the attendees a pictorial or photographic history of the deceased life. Often times, this is accomplished by the surviving members selecting a series of photographs and/or memorabilia and mounting those items onto display boards such that the attendees can view the objects presented at the funeral ceremony. Today, it is not uncommon to have some of the pictures and/or memorabilia stored electronically on a DVD or computer hard drive and then displaying the stored items the on an audiovisual screen or monitor in a recurring loop such that any of the attendees can view the displayed items at their convenience. These presentations allow the attendees to view and reflect upon the decedent's life and accomplishments with relative ease and professionalism.

In most cases, however, the memorabilia and photographs selected for display are chosen by members of the decease's family and/or friends after the individual has passed away and while the family and/or friends are in a state of mourning and loss. As a result, the items displayed may not be those that the deceased would have chosen had they taken the time to make their selections prior to their death. In addition, since the individual is already deceased, there is no way for them to communicate what the important events were in their life.

For many people, their religious views and commitment to their faith is a cornerstone of their life, beliefs and choices. It provides not only a moral compass for their life's journey, but aids them in making decisions during their lifetime and in dealing with life's downturns and tragedies. Yet after their demise, there exists no structured way to put the individual's life in perspective relative to their faith and beliefs. Photographs, by themselves, cannot capture the defining moments in an individual's life that are related or directly tied to their faith and their beliefs.

It is therefore a principle object of this invention to provide a structure and format for collecting and capturing an individual's life story as explained in light of its spiritual significance by that individual prior to their demise.

It is a further object of this invention that the aspects of the individual's life story be captured and stored in a digital format so that the individual's life story can be made available to all future generations through the world wide internet.

These and other features and advantages of this disclosure will become apparent to one skilled in the art upon examination of the following drawings and detailed description. It is intended that all such additional features and advantages be included within the scope of the present invention.

### BRIEF SUMMARY OF THE INVENTION

The present invention is a structured method for collecting and capturing an individual's life story as explained in light of its spiritual significance by that individual prior to their demise. The method comprises the steps of causing the individual, while alive, to create an acoustical and visual presentation of four distinct verbal and visual parts. These parts being:
a. the introduction and greeting spoken in a future sense by the individual,
b. the purpose of the recording as told by the individual,
c. a discussion of faith related events significant to the individual, and
d. a faith based closing by the individual spoken in a future sense.

Once captured, the faith based legacy can be presented at the individual's visitation, funeral or at any later date a viewer chooses to view the captured information.

### BRIEF DESCRIPTION OF THE DRAWINGS

These and other inventive features, advantages and objects will appear in the detailed description of the invention when considered in connection with the accompanying drawings in which similar reference characters denote similar elements throughout the several views and wherein:

FIG. 1 depicts a first individual being digitally recorded by a second individual;

FIG. 2 depicts a flow chart listing the order of the four basic parts of the structured faith based legacy; and

FIG. 3 depicts a flow chart of the components of the third basic part of the structured faith based legacy.

### DESCRIPTION OF THE PREFERRED EMBODIMENT OF THE INVENTION

The present invention recognizes and addresses the various drawbacks and limitations of the various approaches for presenting an individual's life story in relation to their beliefs after they are deceased. Additional objects and features of the invention are set forth in, or will be apparent to those of ordinary skill in the art, from the detailed description that follows. It should be further appreciated that modifications and variations to the specifically illustrated and disclosed features hereof may be practiced in various embodiments and uses of this invention without departing from the spirit and scope thereof. Such variations may include, but are not limited to, substitutions of the equivalent means, features, backgrounds and materials for those shown or discussed, changing the order of the items in the structured flow charts and/or eliminating a specific step in the flow charts.

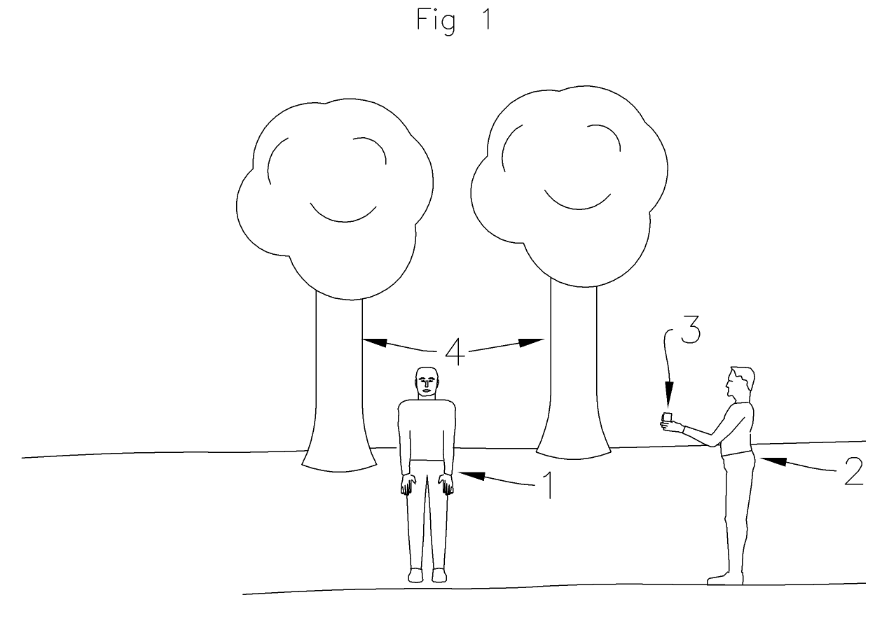

FIG. 1 depicts a first named individual 1 being digitally recorded by a second named individual 2 with a digital acoustical and visual, also referred to as audiovisual, capturing device 3. In the background are shown trees however, any appropriate background chosen by a first individual 1 could be utilized to set the stage for the digital recording.

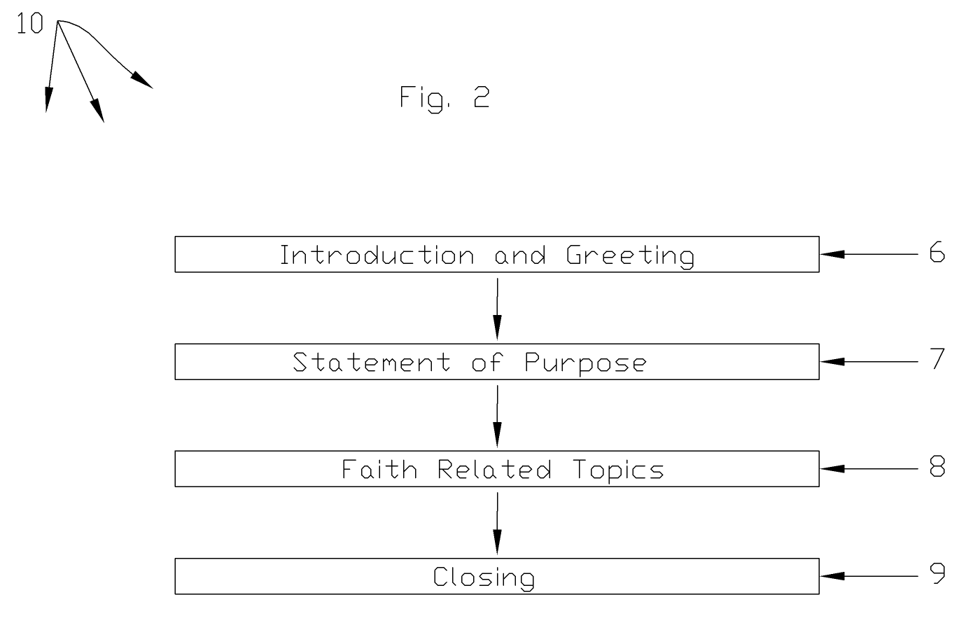

FIG. 2 depicts the flow chart 5 of the four basic parts of the structured faith based legacy of a first named individual 1 that is to be captured by the digital audiovisual capturing device 3 shown in FIG. 1. The first step in the faith based legacy 5 is the creation and digital capture of the introduction and/or greeting 6 whereby a first named individual's 1 name and a select few memorabilia and/or photographs of the first named individual 1 are presented and digitally captured along with background music as chosen by the first named individual 1. The second step is the creation and digital capture of the purpose 7, or reason, the first named individual 1 has chosen to create their faith based legacy. The specific reasons and background setting for a first named individual's 1 statement of the purpose 7 for creating the faith based legacy is chosen by the first named individual 1. The third step is the creation and digital capture of the first named individual's 1 faith related topics 8 that the first named individual 1 desires to share with others after the first named individual 1 is deceased. The structured format for the faith related topics 8 are listed in greater detail below. The final step is the creation and digital capturing of a closing 9 to the faith based legacy which is also explained in greater detail below.

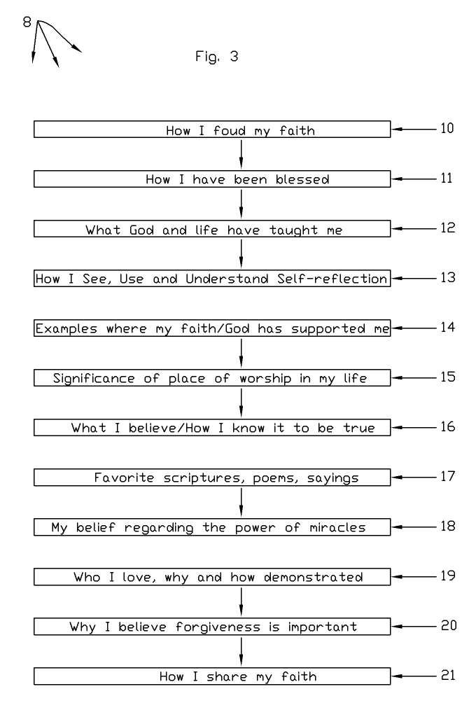

FIG. 3 depicts the structured flow chart for the creation and digital capturing of the faith related topics 8. The first step 10 in the faith related topics 8 is for the first named individual to provide a background on their faith. In particular, this is an explanation of the moment or event in their life that caused them to fully embrace their faith and belief in their God. The second step 11 is for the first named individual 1 to share their blessings. This explains how they believe they have been blessed in life by God and what those blessings are. These blessings from God can include, but is not limited to, such items as their family, friends, career, laughter, their sense of humor, personal attributes or the like. The third step 12 is an explanation of the lessons the first named individual 1 has learned. These are lessons on what God and life has taught the first named individual 1. The forth step 13 is the first named individual's 1 beliefs in prayer and meditation. This is an explanation of how the first named individual 1 sees, uses and understands self-reflection as it relates to their faith. The fifth step 14 is the first named individual's 1 strengths. This is examples from the first named individual's 1 life where their faith and God has supported them.

The sixth step 15 is an explanation of the institutions or places of significance to them as it relates to how they worship in their faith. The seventh step 16 includes examples and explanations of what the first named individual 1 believes in their faith and how they know that belief to be true. The eighth step 17 includes readings, quotes and/or poems related to their faith that have special significance, or meaning, to them and an explanation as to why the readings, quotes or poems are significant to them. The ninth step 18 includes an explanation of the first named individual's 1 belief regarding the power of miracles. The tenth step 19 includes statements of who the first named individual 1 loved, why they loved them and how they demonstrated their love for them. The eleventh step 20 is on forgiveness. This is where the first named individual 1 explains why they believe forgiveness is important for them selves, for others and for their faith. The twelfth and last step 21 in the faith related topic part 8 is where the first named individual 1 shares their evangelism. This includes capturing how they have shared and witnessed their faith by examples.

The background for the capturing of the digital information for the faith related topics can be anywhere of significance to the first named individual 1, such as their place of worship, their home, a lake, a place of solitude, whatever the first named individual 1 deems is most appropriate for their faith based legacy. However, it is important that person be alive and moving if possible.

The closing 9 of the faith based legacy includes the creation and digital capturing of the first named individual's 1 faith based predictions, their final goodbye and their statement of love. The closing 9 can include a statement of faith concerning salvation, a statement of faith concerning the reuniting of souls and a faith statement concerning eternity, heaven, the other side, a better place or other similar faith based statement. It is important that the closing words be spoken of in the future sense. In its preferred embodiment, the closing 9 would take place either outdoors, such as in a park, garden, beach or forest or in a symbolic spiritual place; such as a church, synagogue, temple or the like. It is also important that the first named individual 1 be recorded at least one time alive and moving as this aids those attending a funeral with closure. As the faith based legacy closes, the first named individual 1 is seen walking away out of the camera view. This represents a symbolic return to God and/or nature.

After all of the above steps are audio/visually created and digitally captured, additional photographs or other videos selected by the first named individual 1 are also captured digitally. During the actual creation of the faith based legacy, the additional photographs and/or other videos are interspersed with the faith related topics 8 in their appropriate places. For example only, a picture of the first named individual's primary place of worship can be inserted in the sixth step 15 where they refer to their place of worship. Once any additional photographs and/or videos are interspersed with the faith related topics 8, the entire digital record is stored in a host computer for distribution through the internet and/or on DVD's or other recordable media for distribution to others.

I claim:

1. A method of digitally capturing an individual's life story in light of said life's story spiritual significance comprising the steps of:
a. causing said individual, while alive, to prepare a message, wherein said message comprises:
i. introductory statements;
ii. statements of the purpose for capturing said life story;
iii. statements on faith related topics, and
iv. closing statements; and
b. acoustically and visually digitally capturing said individual presenting said statements in i through iv above; and
c. storing said digitally captured statements in an electronic medium.

2. The method of claim 1 wherein background music is digitally captured in step b.

3. The method of claim 1 wherein memorabilia from said individual is digitally captured in step b.

4. The method of claim 1 wherein said acoustically and visually captured presentation of statements of step b includes digitally captured background scenes.

5. The method of claim 1 wherein said closing statements are acoustically and visually digitally captured in an outdoor location and depicts said individual moving out of view of said digital capture.

6. A method of digitally capturing an individual's life story in light of said life's story spiritual significance comprising the steps of:
a. causing said individual, while alive, to prepare a message, wherein said message comprises:
i. introductory statements;
ii. statements of the purpose for capturing said life story;
iii. statements on faith related topics, wherein said faith related topics comprises:
1. statements as to how said individual found their faith;
2. statements as to how said individual has been blessed with their gifts from God;
3. statements as to what God and life has taught said individual;
4. statements as to how said individual see, use and understand self-reflection;
5. statements about where God and said individual's faith have supported them in said life;
6. statements about the significance of said individual's place of worship;
7. statements of what said individual believes and how said individuals knows said beliefs are true;
8. statements of said individuals favorite scriptures, poems and sayings;
9. statements of said individual's belief in the power of miracles;
10. statements of who said individual loved, why they loved said who's and how said individual demonstrated their love to said who's;
11. statements on why said individual believes forgiveness is important; and
12. how said individual shares their faith; and
iv. closing statements; and
b. acoustically and visually digitally capturing said individual presenting said statements in i through iv above; and
c. storing said digitally captured statements in an electronic medium.

7. The method of claim 6 wherein background music is digitally captured in step b.

8. The method of claim 6 wherein memorabilia from said individual is digitally captured in step b.

9. The method of claim 6 wherein said acoustically and visually captured presentation of statements of step b includes digitally captured background scenes.

10. The method of claim 6 wherein said closing statements are acoustically and visually digitally captured in an outdoor location and depicts said individual moving out of view of said digital capture.

11. A structured format for creating an individual's life story in light of said life's story spiritual significance, said format comprising the elements of:
a. causing said individual, while alive, to prepare a message, wherein said message comprises:
i. introductory statements;
ii. statements of the purpose for capturing said life story;
iii. statements on faith related topics, wherein said faith related topics comprises; and
iv. closing statements; and
b. acoustically and visually digitally capturing said individual presenting said statements in i through iv above; and
c. storing said digitally captured statements in an electronic medium.

12. The structured format of claim 11 wherein background music is digitally captured in step b.

13. The structured format of claim 11 wherein memorabilia from said individual is digitally captured in step b.

14. The structured format of claim 11 wherein said acoustically and visually captured presentation of statements of step b includes digitally captured background scenes.

15. The structured format of claim 11 wherein said closing statements are acoustically and visually digitally captured in an outdoor location and depicts said individual moving out of view of said digital capture.

16. A structured format for creating an individual's life story in light of said life's story spiritual significance, said format comprising the elements of:
a. causing said individual, while alive, to prepare a message, wherein said message comprises:
i. introductory statements;
ii. statements of the purpose for capturing said life story;
iii. statements on faith related topics, wherein said faith related topics comprises:
1. statements as to how said individual found their faith;
2. statements as to how said individual has been blessed;
3. statements as to what God and life has taught said individual;
4. statements as to how said individual see, use and understand self-reflection;
5. statements about where God and said individual's faith have supported them in said life;
6. statements about the significance of said individual's place of worship;
7. statements of what said individual believes and how said individuals knows said beliefs are true;
8. statements of said individuals favorite scriptures, poems and sayings;
9. statements of said individual's belief in the power of miracles;
10. statements of who said individual loved, why they loved said who's and how said individual demonstrated their love to said who's;
11. statements on why said individual believes forgiveness is important; and
12. how said individual shares their faith; and
iv. closing statements; and
b. acoustically and visually digitally capturing said individual presenting said statements in i through iv above; and
c. storing said digitally captured statements in an electronic medium.

17. The structured format of claim 16 wherein background music is digitally captured in step b.

18. The structured format of claim 16 wherein memorabilia from said individual is digitally captured in step b.

19. The structured of claim 16 wherein said acoustically and visually captured presentation of statements of step b includes digitally captured background scenes.

20. The structured of claim 16 wherein said closing statements are acoustically and visually digitally captured in an outdoor location and depicts said individual moving out of view of said digital capture.
